(19) United States
(12) Patent Application Publication
(10) Pub. No.: US 2026/0065238 A1
(43) Pub. Date: Mar. 5, 2026

(54) METHOD AND APPARATUS FOR PROVIDING COMMENT VIEW

(71) Applicant: KAKAO CORP., Jeju-si (KR)

(72) Inventor: A Rom KIM, Seongnam-si (KR)

(73) Assignee: KAKAO CORP., Jeju-si (KR)

(21) Appl. No.: 19/298,020

(22) Filed: Aug. 12, 2025

(30) Foreign Application Priority Data
Aug. 28, 2024 (KR) 10-2024-0116234

(51) Int. Cl. G06Q 50/00; G06F 3/0482; G06F 3/0485

(52) U.S. Cl. CPC G06Q 10/40; G06F 3/0482; G06F 3/0485

(57) ABSTRACT

A method and apparatus for providing a comment view is disclosed. A terminal receives a first user input accessing a comment view of a post and receives a comment list of the post from a server. The terminal acquires identification information related to a user and corresponding comment location information. Based on a screen display attribute terminal, at least a portion of comments is displayed on the comment view. When a comment corresponding to the comment location information is not displayed, a button is activated to control the comment view according to the comment location information. In response to a second user input selecting the button, the terminal controls the comment view to display the comment corresponding to the comment location information and deactivates the button. The method enables context-aware navigation of comment content across sessions and devices.

### CROSS-REFERENCE TO RELATED APPLICATION

This application claims the benefit of Korean Patent Application No. 10-2024-0116234 filed on Aug. 28, 2024, in the Korean Intellectual Property Office, the entire disclosure of which is incorporated herein by reference for all purposes.

### BACKGROUND

### Technical Field

The disclosure relates to a method and an apparatus for providing a comment view, and more particularly, to a method and an apparatus for providing a comment view according to an input of a user.

### Description of the Related Art

Recently, various online community platforms have emerged due to the development of the Internet and mobile devices. In particular, a function in which users share opinions and interact with each other through comments on posts is being considered very important. Comment systems are widely used in online platforms including forums, blogs, and social networking services (SNS). These systems typically display user-submitted comments in a sequential list associated with a particular post.

However, conventional implementations often lack the ability to track a user's viewing position within a lengthy comment thread. As a result, users who return to a comment thread after navigating away are typically forced to manually scroll through potentially large volumes of comments to locate where they previously left off.

In existing systems, bookmark-like features may be implemented, but these are often user-managed and lack integration with the comment display logic. Furthermore, many systems fail to consider the screen size or orientation of the terminal when rendering comment views, which can lead to inconsistent user experiences across devices. Additionally, the user interface elements for navigation are typically static and not responsive to real-time user behavior or viewport visibility. These limitations result in inefficient navigation, excessive scroll operations, and a degraded user experience (e.g., inefficient user experiences and impose a computational burden on both the user and system).

There is a need for a method that improves the way a computing system tracks, renders, and navigates comment views in a manner that adapts to user behavior and device constraints. The disclosed method addresses these issues by introducing a user-specific, device-aware comment view system that enables automated position tracking, context-aware navigation controls, and dynamic state management tailored to user interaction patterns. This provides a concrete technical solution to challenges associated with comment rendering in computing environments.

### BRIEF SUMMARY

The system improves user interaction with lengthy comment threads by enabling seamless return to the last read comment across different sessions and devices. This is achieved by maintaining user-specific comment position data for each post, which is stored either on the terminal or on a server and retrieved when the comment view is revisited. Unlike conventional bookmarking, the method adapts to device-specific display characteristics and user login state to determine whether the relevant comment appears within the visible portion of the screen.

A context-aware button is activated only when the previously read comment is not visible in the current view. This button allows the user to return directly to the stored position. It is automatically deactivated or reactivated based on user actions such as scrolling or refreshing, depending on whether the relevant content becomes visible. The system also updates stored comment positions based on thresholds tied to scrolling behavior, ensuring that the recorded location reflects actual user activity without requiring manual input.

This approach provides a user interface that adjusts dynamically to both device and user behavior. By combining local and remote data management, display-adaptive rendering, and automated state tracking, the method addresses a specific technical problem in navigating large volumes of content efficiently. Accordingly, the described method, apparatus, and system implement a specific technical solution that enhances the operation of a computing device.

Namely, the disclosed subject matter provides a method and apparatus for presenting a comment view that enables individualized, device-adaptive, and context-sensitive navigation. The method includes acquiring user-specific comment location information and conditionally presenting a user interface control element based on whether the last-read comment is currently visible in the viewport.

The system dynamically manages state information by storing and updating comment location data either locally or on a server. Comment rendering is adapted to display characteristics such as screen size, resolution, and viewport configuration. In response to user scroll input or update requests, the system may automatically adjust or refresh comment position data without requiring manual intervention. This leads to a responsive and efficient interface that improves usability and system performance.

Unlike generic user interface implementations, the disclosed method operates through a combination of real-time display analysis, content-based index tracking, and context-dependent interface control. These features contribute to a practical application that improves the operation of computing devices in presenting large-scale dynamic content, consistent with subject matter deemed eligible under prevailing legal standards.

For instance, according to an aspect, there is provided a method, performed by a user terminal, of providing a comment view, including receiving a first user input accessing a comment view of a post, receiving a comment list of the post from a server, acquiring identification information related to a user, acquiring comment location information corresponding to the post and the identification information, displaying at least a portion of comments of the comment list on the comment view based on a screen display attribute of the user terminal, when a comment corresponding to the comment location information is not displayed on the comment view, activating a button to control the comment view according to the comment location information, and in response to a second user input selecting the button, controlling the comment view so that the comment corresponding to the comment location information is displayed and deactivating the button.

The method may further include storing location information of the at least the portion of comments corresponding to the post and the identification information, wherein the comment location information may be location information pre-stored at a previous time point of accessing the comment view of the post by using the identification information.

The method may further include, in a state in which the button is deactivated, reactivating the button based on content displayed on the comment view as a result of the comment view being controlled by a predetermined fourth user input distinguished from a third user input.

The reactivating of the button may include at least one of, in response to a scroll input of the user while the button is deactivated, reactivating the button when the at least the portion of comments is displayed on the comment view, and in a state in which the button is deactivated, newly receiving a latest comment list from a server according to receiving an update request and reactivating the button by displaying at least a portion of comments of the latest comment list on the comment view.

The acquiring of the identification information related to the user may include at least one of acquiring identification information from the user terminal, and acquiring identification information corresponding to an account of the user from a server.

The acquiring of the comment location information corresponding to the post and the identification information may include at least one of acquiring comment location information corresponding to the post and the identification information stored in the user terminal, and acquiring comment location information corresponding to the post and the identification information from a server.

The method may further include in a state in which the button is activated, deactivating the button in response to a predetermined third user input distinguished from the second user input.

The deactivating of the button in response to the third user input may include at least one of, in a state in which the button is activated, deactivating the button in response to a result of a scroll input of a user, and in a state in which the button is activated, deactivating the button while a scroll input of a user is being input.

The method may further include at least one of updating the comment location information according to a predetermined first condition, and updating the stored location information according to a predetermined second condition.

The updating of the comment location information according to the predetermined first condition may include according to a determination that a comment corresponding to an index corresponding to a predetermined difference is displayed on the comment view based on an index corresponding to the comment location information of the comment list, updating the comment location information in response to the index corresponding to the predetermined difference.

The updating of the stored location information according to the predetermined second condition may include according to a determination that a latest comment corresponding to an index corresponding to a predetermined difference is displayed on the comment view based on an index corresponding to the stored location information of the comment list, updating the stored location information in response to the index corresponding to the predetermined difference.

The method may further include at least one of identifying at least one of the first condition and the second condition at predetermined time intervals, and identifying at least one of the first condition and the second condition according to an update request.

According to an aspect, there is provided a user terminal including at least one processor, and memory storing a program readable by the at least one processor, wherein the program includes instructions that may cause the at least one processor to receive a first user input accessing a comment view of a post, receive a comment list of the post from a server, acquire identification information related to a user, acquire comment location information corresponding to the post and the identification information, display at least a portion of comments of the comment list on the comment view based on a screen display attribute of the user terminal, when a comment corresponding to the comment location information is not displayed on the comment view, activate a button to control the comment view according to the comment location information, and in response to a second user input selecting the button, control the comment view so that the comment corresponding to the comment location information is displayed and deactivate the button.

The program may include instructions that may further cause the at least one processor to store location information of the at least the portion of comments corresponding to the post and the identification information, wherein the comment location information may be location information pre-stored at a previous time point of accessing the comment view of the post by using the identification information.

The program may include instructions that may further cause the at least one processor to, in a state in which the button is deactivated, reactivate the button based on content displayed on the comment view as a result of the comment view being controlled by a predetermined fourth user input distinguished from a third user input.

The reactivating of the button may include at least one of, in response to a scroll input of the user while the button is deactivated, reactivating the button when the at least the portion of comments is displayed on the comment view, and in a state in which the button is deactivated, newly receiving a latest comment list from a server according to receiving an update request and reactivating the button by displaying at least a portion of comments of the latest comment list on the comment view.

The program may include instructions that may further cause the at least one processor to, in a state in which the button is activated, deactivate the button in response to a predetermined third user input distinguished from the second user input.

The program may include instructions that may further cause the at least one processor to execute at least one of updating the comment location information according to a predetermined first condition, and updating the stored location information according to a predetermined second condition.

The updating of the comment location information according to the predetermined first condition may include, according to a determination that a comment corresponding to an index corresponding to a predetermined difference is displayed on the comment view based on an index corresponding to the comment location information of the comment list, updating the comment location information in response to the index corresponding to the predetermined difference.

The updating of the stored location information according to the predetermined second condition may include, according to a determination that a latest comment corresponding to an index corresponding to a predetermined difference is displayed on the comment view based on an index corresponding to the stored location information of the comment list, updating the stored location information in response to the index corresponding to the predetermined difference.

Additional aspects of embodiments will be set forth in part in the description which follows and, in part, will be apparent from the description, or may be learned by practice of the disclosure.

The method and apparatus described herein provide several technical advantages over conventional comment rendering systems.

First, the approach enables individualized tracking and retrieval of comment location information for each user and each post, which is maintained either locally on the terminal or remotely on a server. This structure allows the system to resume comment views from the last read position without requiring manual bookmarking or persistent open sessions. The ability to coordinate between local and remote storage paths improves performance by reducing network latency and supporting continuity even in limited connectivity environments.

Second, the method includes dynamic user interface control based on whether a relevant comment is within the viewport. The system determines this state in real time and conditionally activates a control element only when needed. This behavior minimizes unnecessary UI clutter and improves usability, especially in limited screen display environments. The control element is deactivated or reactivated based on specific user inputs and viewport content changes, creating a responsive and context-aware user interface that goes beyond simple scroll functions.

Third, the system automatically updates comment location information based on defined thresholds related to user activity. For example, the system can determine when a user has scrolled past a certain number of comments beyond the last read position and update stored state accordingly. This reduces reliance on manual input, maintains accurate state persistence, and adapts the interface to evolving user behavior. These improvements enhance computational efficiency and deliver a more seamless and technically sophisticated user experience.

### BRIEF DESCRIPTION OF THE SEVERAL VIEWS OF THE DRAWINGS

These and/or other aspects, features, and advantages of the disclosure will become apparent and more readily appreciated from the following description of embodiments, taken in conjunction with the accompanying drawings of which:

FIG. 1 is a diagram illustrating an outline of a system for providing a comment view according to an embodiment;

FIG. 2 is a flowchart illustrating an operation of a terminal that provides a comment view according to an embodiment;

FIG. 3 is a diagram illustrating an example of acquiring comment location information corresponding to identification information related to a post and a user, according to an embodiment;

FIG. 4 is a diagram illustrating an example of displaying a comment on a comment view based on a screen display attribute of a user terminal, according to an embodiment;

FIG. 5 is a diagram illustrating a comment view displayed according to a user input accessing a comment view of a post, according to an embodiment;

FIG. 6 is a diagram illustrating whether a button for controlling a comment view is activated, according to an embodiment;

FIG. 7 is a flowchart illustrating an operation of updating comment location information to changed comment location information, according to an embodiment; and

FIG. 8 is a diagram illustrating an example hardware configuration of a system for providing a comment view, according to an embodiment.

### DETAILED DESCRIPTION

The following detailed structural or functional description is provided as an example only and various alterations and modifications may be made to the embodiments. Accordingly, the embodiments are not construed as limited to the disclosure and should be understood to include all changes, equivalents, and replacements within the idea and the technical scope of the disclosure.

With regard to the description of the drawings, similar reference numerals may be used to refer to similar or related elements. It is to be understood that a singular form of a noun corresponding to an item may include one or more of the things, unless the relevant context clearly indicates otherwise.

As used herein, each of such phrases as “A or B,” “at least one of A and B,” “at least one of A or B,” “A, B or C,” “at least one of A, B and C,” and “at least one of A, B, or C,” may include any one of, or all possible combinations of the items enumerated together in a corresponding one of the phrases.

As used herein, such terms as “1^{st}” and “2^{nd},” or “first” and “second” may be used to simply distinguish a corresponding component from another, and does not limit the components in other aspects (e.g., importance or order). For example, a first component may be referred to as a second component, or similarly, the second component may be referred to as the first component within the scope of the present disclosure.

It is to be understood that if a component (e.g., a first component) is referred to, with or without the term “operatively” or “communicatively,” as “coupled with,” “coupled to,” “connected with,” or “connected to” another component (e.g., a second component), it means that the component may be coupled with the other component directly (e.g., by wire), wirelessly, or via a third component.

As used herein, the singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined herein, all terms used herein including technical or scientific terms have the same meanings as those generally understood by one of ordinary skill in the art. Terms defined in dictionaries generally used should be construed to have meanings matching contextual meanings in the related art and are not to be construed as an ideal or excessively formal meaning unless otherwise defined herein.

Hereinafter, embodiments will be described in detail with reference to the accompanying drawings. When describing the embodiments with reference to the accompanying drawings, like reference numerals refer to like components and a repeated description related thereto will be omitted.

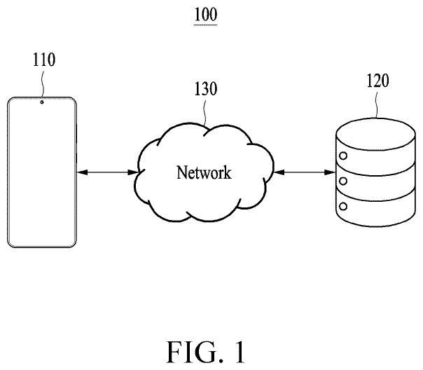

FIG. 1 is a diagram illustrating an outline of a system for providing a comment view according to an embodiment.

Referring to FIG. 1, a system 100 for providing a comment view according to an embodiment may include a terminal 110 and a server 120. The server 120 and the terminal 110 may be connected to each other via a network 130. A detailed description of the configuration and operation of the server 120 or the terminal 110 is described below.

A comment view may be an interface displaying comments on a screen of the terminal 110. For example, the comment view may be an interface that aligns and displays respective comment elements included in a comment list for each post.

The comment view may be used in an online community service. The online community service may include a service that allows a plurality of users to interact by transmitting various types of content, such as text, images, videos, and links, in real time through the network 130 such as wireless Internet or a wireless communication network, and services related thereto. For example, the online community service may allow users to gather around a particular topic or interest and exchange information, engage in discussions, and interact with each other. For example, portals, bulletin boards, forums, groups and the like may be formed based on a particular topic or interest.

Hereinafter, embodiments of a method performed in an online community service is described, but the embodiments may be substantially identically performed in a social network service (SNS). An SNS may include a service that allows users to connect with friends, family, and colleagues based on a personal profile and communicate by sharing daily updates, photos, videos, links, and the like. In addition, the embodiments may be substantially identically applied to a service that appropriately combines a social network and an online community.

The server 120 may perform operations of providing comment information to provide a comment view. The server 120 according to an embodiment may include a comment information providing server, or may be a partial module included in the comment information providing server, or may be a separate server linked with the comment information providing server. The server 120 may transmit a comment list for a particular post to the terminal 110 in the form of a list including comment elements. Additionally, the server 120 may provide comment information to the terminal 110 to provide a comment view in the form of a comment element including comment writer information, comment writing time, and the like. The comment view may be provided in the form of an interface via an application (app) or the web.

The server 120 according to an embodiment may generate a user account related to an online community service, in response to a service subscription request of a user. The user account may correspond to information used to identify a user subscribed to a service on a server. The user may use the comment view of the online community service through the user account.

The online community service according to an embodiment may include services related to the transmitting and receiving of posts and comments, and may further include services provided to enhance user convenience. The online community service may provide functions for posts and comment services through the terminal 110, and for example, may provide at least one of a function for generating and editing a post or comment on the terminal 110, a function for bookmarking at least one of a post or comment, a function for sharing a post or comment, and a function for providing a notification when a post or comment is registered.

The terminal 110 may be an apparatus of users who receive a comment view, and may include, for example, a personal computer (PC), a netbook, a notebook, a personal digital appliance (PDA), a smartphone, a wearable device, and various apparatuses that perform similar functions. An app or web browser linked to the server 120 may be run on the terminal 110, and a user may use the comment view provided from the server 120 through the app or web browser run on the terminal 110.

The terminal 110 according to an embodiment may provide a user interface including a comment view to the user. The comment view may be an interface that displays at least a portion of the comments among all comments for a particular post. A comment list displayed in the comment view may vary depending on screen display attributes (e.g., display size, width-to-height ratio, resolution, landscape-portrait mode, and the like) of the terminal.

For example, the comment view may include an interface for writing, editing, or deleting comments on other users' comments or new comments, and an interfacing object for refreshing the comment list. The comment view may also include an interfacing object for scrolling to check other comments other than the comment list displayed on the screen. The interfacing object may be implemented to perform a predetermined function through interaction with the user, and may include, for example, a button, an input field, a switch, or the like.

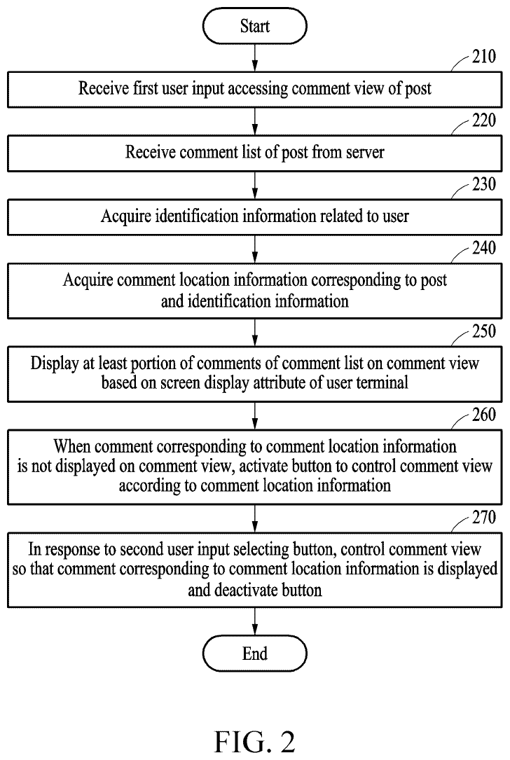

FIG. 2 is a flowchart illustrating an operation of a terminal that provides a comment view according to an embodiment. A method of providing a comment view may be performed through operations 210 to 270. In the following embodiments, each operation may be performed sequentially, but not necessarily performed sequentially. For example, an order in which each operation is performed may be changed, and at least two operations may be performed in parallel.

A server that provides comment information to provide a comment view may correspond to the server 120 of FIG. 1. Hereinafter, a server that provides comment information may be briefly referred to as a “server”. A terminal that receives comment information may correspond to the terminal 110 of FIG. 1. Hereinafter, a terminal that receives comment information may be briefly referred to as a “terminal”.

In operation 210, the terminal 110 may receive a first user input accessing a comment view of a post. According to an embodiment, the terminal 110 may display a post list interface including an interfacing object for receiving the first user input. The terminal 110 may display a comment view access interfacing object for accessing a comment view of a particular post using the post list interface. The terminal 110 may display a comment view access interfacing object corresponding to each post in a post list displayed on the post list interface. Alternatively, the terminal 110 may display a comment view access interfacing object for accessing a comment view of a particular post on the post interface displaying the particular post. Depending on embodiments, when the comment view is accessed, the terminal 110 may display the comment view and the post together, or may display only the comment view without displaying the post. The comment view access interfacing object may include a button for accessing the comment view, and the total number of comments for each post may be displayed together.

In operation 220, the terminal 110 may receive a comment list of a post from the server 120. In response to receiving the first user input, the server 120 may acquire a comment list of a post corresponding to the first user input from a database or the like of the server 120. For example, the server 120 may acquire a list of all comments for a given post, a list of comments of a predetermined number, or a list of comments written within a predetermined time period from a time point of receiving an input. The server 120 may transmit the comment list to the terminal 110 in the form of a list including comment elements or nodes.

In operation 230, the terminal 110 may acquire identification information related to a user. An order of performing the operation 230 of acquiring the identification information related to the user may be changed, and may be performed in parallel with at least one other operation. The identification information related to the user (hereinafter, “identification information”) may be information for distinguishing users or user terminals using the comment view from each other.

According to an embodiment, the identification information may be acquired from the terminal 110. For example, the identification information may be determined based on unique identification information of the terminal, such as international mobile equipment identity (IMEI), media access control address (MAC address), and the like of a terminal. In this way, even when a user is not logged in, the user may use the comment view provided differently for each user using the unique identification information of the terminal.

According to an embodiment, the terminal 110 may acquire identification information corresponding to the user's account from the server 120. The identification information corresponding to the user's account may be acquired when the user logs in to an online community service that performs the method of providing a comment view. The server 120 may retrieve the identification information from a database or the like of the server 120 based on account information of the logged-in user, and transmit the identification information to the terminal 110.

In operation 240, the terminal 110 may acquire comment location information corresponding to the post and identification information. The comment location information may be, but is not necessarily limited to, location information of the most recently read comment, location information of a comment close thereto, or the latest comment location information, based on a time point when the user last checked the comment view of the post for which access is requested in operation 210. The terminal 110 may acquire the comment location information that is managed differently for each post and user using the post and identification information.

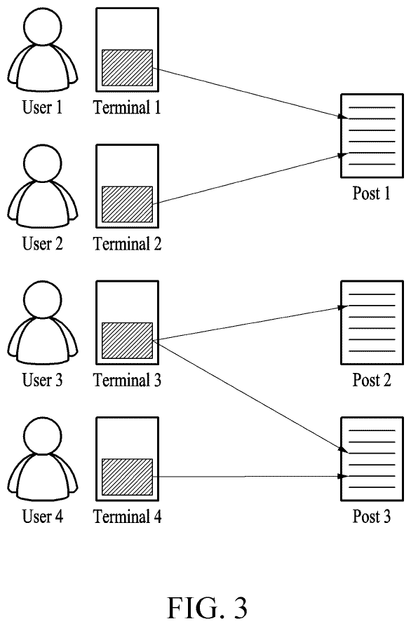

For example, FIG. 3 illustrates an example of acquiring comment location information for each post corresponding to identification information for each user when there are a plurality of users. For example, when there are four users and three posts, the location of a comment last viewed by user 1 for post 1 may be a comment corresponding to the second of the comment list. With respect to the same post 1, the location of a comment last viewed by user 2 may be a comment corresponding to the fourth of the comment list. The location of a comment last viewed by user 3 for post 3 may be a comment corresponding to the third of the comment list, and the location of a comment last viewed by user 4 for the same post 3 may be a comment corresponding to the fourth of the comment list. That is, even for the same post, different comment location information may be acquired depending on the identification information related to the user. Additionally, the location of a comment last viewed by user 3 for post 2 may be a comment corresponding to the third of the comment list. The location of a comment last viewed by the same user 3 for post 3 may be a comment corresponding to the second of the comment list. That is, even when the identification information is related to the same user, different comment location information may be acquired depending on the post.

According to an embodiment, the comment location information may be comment location information stored in the terminal 110. The comment location information may be information stored in a local storage of the terminal 110. For example, the comment location information may be information stored as app data in a cache memory of the terminal 110, but is not necessarily limited thereto. The terminal 110 may acquire the comment location information by inquiring the local storage based on information on a selected post. By acquiring the comment location information by searching the local storage, the terminal 110 may quickly acquire a last read comment location without having to connect to a server separately.

According to an embodiment, the comment location information may be comment location information acquired from the server 120. The comment location information may be information stored in a database of the server 120. The comment location information may be information stored in a database of the server 120 together with post information and identification information. The server 120 may acquire the comment location information by inquiring the database based on the post information and identification information, and may transmit the comment location information to the terminal 110.

In operation 250, the terminal 110 may display at least a portion of the comments of the comment list on the comment view based on screen display attributes of a user terminal. The screen display attributes may be attributes related to a screen display area (e.g., a display) of a terminal, for example, the size of the display, width-to-height ratio, resolution, whether the display is in a landscape mode or portrait mode, and the like. The comment view may be displayed in at least a part of the screen display area of the terminal, and at least a part of the area in which the comment view is displayed on the screen display area of the terminal may be referred to as a viewport of the comment view. The size of the viewport of the comment view may be adjusted according to the screen display attributes of the terminal. According to an embodiment, the size of the viewport of the comment view may be arbitrarily adjusted by the user.

According to an embodiment, the terminal 110 may display a larger comment list as the screen display area of the user terminal increases. Although the terminal 110 displays comments on the comment view based on the same comment location information, the range of the comment list displayed may vary according to the size of the different screen display areas for each user terminal. In addition, even when the user terminals have the same size of the screen display area, the range of the comment list displayed may vary depending on a viewport size of the comment view adjusted by user settings of each terminal.

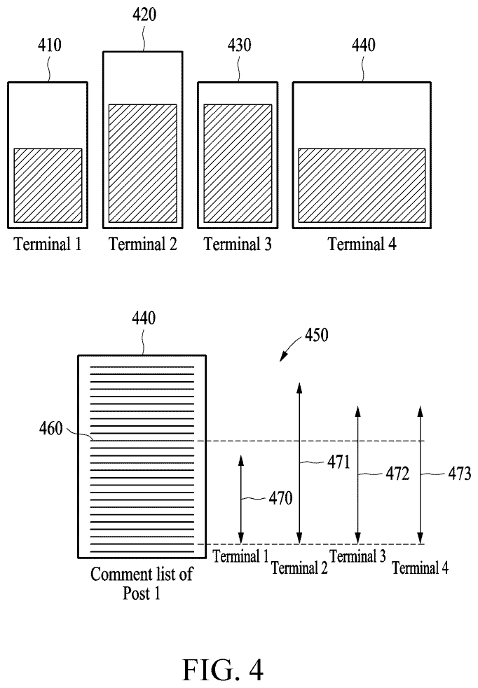

FIG. 4 illustrates an example of displaying at least a portion of the comments of a comment list on a comment view based on a screen display attribute of a terminal. For example, a screen display area 410 of terminal 1, a screen display area 420 of terminal 2, a screen display area 430 of terminal 3, and a screen display area 440 of terminal 4 may be different from each other. The shaded parts in the screen display areas 410, 420, 430, and 440 may be viewports of the comment view. In addition, all terminals may have accessed the comment view of the same post 1, and comment location information 460 may all be the same.

According to an embodiment, when the comment view is accessed, at least a portion of the comments of the comment list may be displayed in order of the most recently written comments. The comment range displayed on each terminal may vary depending on the screen display attributes of each terminal. In addition, depending on the screen display attributes, whether a comment corresponding to the comment location information 460 is included in the comment range displayed on each terminal may vary. For example, terminal 1 may display comments as much as comment range 1 470. Compared to the screen display area of terminal 1, terminal 2, which has the same horizontal width but a larger vertical screen display area, may display comments as much as comment range 2 471, and comment range 2 471 may include comments corresponding to the comment location information 460. Terminal 3, which has the same screen display area size as that of terminal 1, may display comments as much as comment range 3 472. Here, terminal 3 may represent a case where the size of the viewport of the comment view is adjusted relatively widely compared to terminal 1. Accordingly, comment range 3 472 may display comments in a larger comment range compared to comment range 1 470 despite having the same screen display area size, and while comment range 1 470 may not include comments corresponding to the comment location information 460, comment range 3 472 may include comments corresponding to the comment location information 460. Terminal 4, which has a screen size with the same vertical width but a larger horizontal width compared to the screen size of Terminal 1, may display comments as much as comment range 4 473.

As further described below, since the comment view of terminal 1 does not display comments corresponding to the comment location information 460, a comment view control button based on the comment location information 460 may be activated. On the other hand, since the comment views of terminals 2 to 4 display comments corresponding to the comment location information 460, the comment view control button based on the comment location information 460 may not be activated.

In operation 260, when a comment corresponding to the comment location information is not displayed on the comment view, the terminal 110 may activate a button to control the comment view according to the comment location information. For example, the terminal 110 may acquire information on a currently displayed comment list, including a start position and an end position of the comment list rendered on the screen, based on a scroll position on the comment view and the size of the viewport of the comment view. The terminal 110 may determine whether the comment corresponding to the comment location information is included in the currently displayed comment list. When the terminal 110 determines that the comment corresponding to the comment location information is not included in the currently displayed comment list, the terminal 110 may activate the button to control the comment view. Alternatively, the terminal 110 may set a divider to be displayed at a position corresponding to the comment location information by registering the comment location information in the comment view. The terminal 110 may check whether the divider is displayed in the comment view. When it is determined that the divider is not displayed in the comment view, the terminal 110 may activate the button to control the comment view.

According to an embodiment, the server 120 may receive information on a currently displayed comment list, including a start position and an end position of a comment list rendered on a screen, from the terminal 110, based on a scroll position on the comment view and the size of the viewport of the comment view. The server 120 may determine whether a comment corresponding to the comment position information is included in the currently displayed comment list. When the server 120 determines that the comment corresponding to the comment position information is not included in the currently displayed comment list, the server 120 may transmit data for activating the button to control the comment view to the terminal 110.

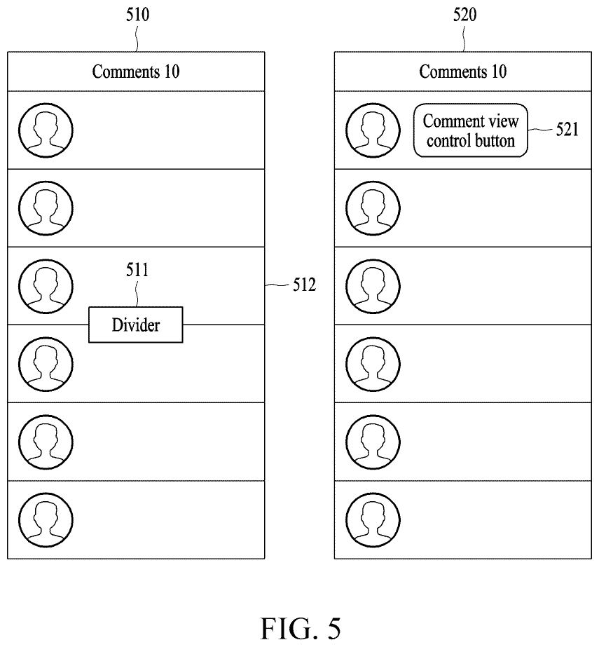

FIG. 5 illustrates an example of a comment view 510 (hereinafter, referred to as “comment view 1”) including comments corresponding to comment location information and a comment view 520 (hereinafter, referred to as “comment view 2”) not including comments corresponding to comment location information. The comment view 1 510 may represent a comment view that includes comments 512 corresponding to comment location information. The comments 512 corresponding to the comment location information may be displayed at the top of a divider 511 to be distinguished from other comments. The divider 511 may include text, symbols, shapes, or the like that indicate that a corresponding location is the location of the last comment read by a user. According to an embodiment, the divider 511 may be managed together with the viewport of the comment view.

The comment view 2 520 may represent a comment view that does not include the comments 512 corresponding to the comment location information. The comment view 2 520 may be a comment view of a case where it is determined that the comments 512 corresponding to the comment location information are not included in the displayed comment list, and may represent a comment view in which a button 521 to control the comment view according to the comment location information (hereinafter, referred to as “button”) is activated. In FIG. 5, the button 521 is displayed at the top for convenience, but the button 521 may be positioned at a different location on the screen display area of the terminal 110. According to an embodiment, the button 521 may be displayed in a floating form and may be moved to a location desired by the user.

In operation 270, in response to a second user input selecting the button, the terminal 110 may control the comment view so that the comments corresponding to the comment location information are displayed, and deactivate the button. When the user selects the activated button in operation 260, the terminal 110 may detect a second user input corresponding to the button. When the second user input is detected, the terminal 110 may control the comment view based on the comment location information. The terminal 110 may control the comment view by adjusting a scroll position of the comment view so that the comments corresponding to the comment location information are displayed on the screen. For example, referring to FIG. 5, in response to the second user input selecting the button 521 in the comment view 2 520, an operation of automatically adjusting the scroll position to move to the comment view 1 510 may be performed. Through this operation, the method of providing the comment view may allow the user to quickly access a desired comment among many comments, thereby reducing search time.

The terminal 110 may deactivate the button by controlling the comment view so that the comments corresponding to the comment location information are displayed. The terminal 110 may simplify the user interface by deactivating (e.g., not exposing) the button 521 and prevent unnecessary interface elements from remaining for the user. For example, the terminal 110 may prevent comments from being hidden due to the button 521 configuration.

According to an embodiment, the terminal 110 may deactivate the button 521 in response to a predetermined third user input distinguished from the second user input while the button 521 is activated. The terminal 110 may include an operation of deactivating the button 521 in response to a result of a user's scroll input while the button 521 is activated, or an operation of deactivating the button 521 while a scroll input is being input.

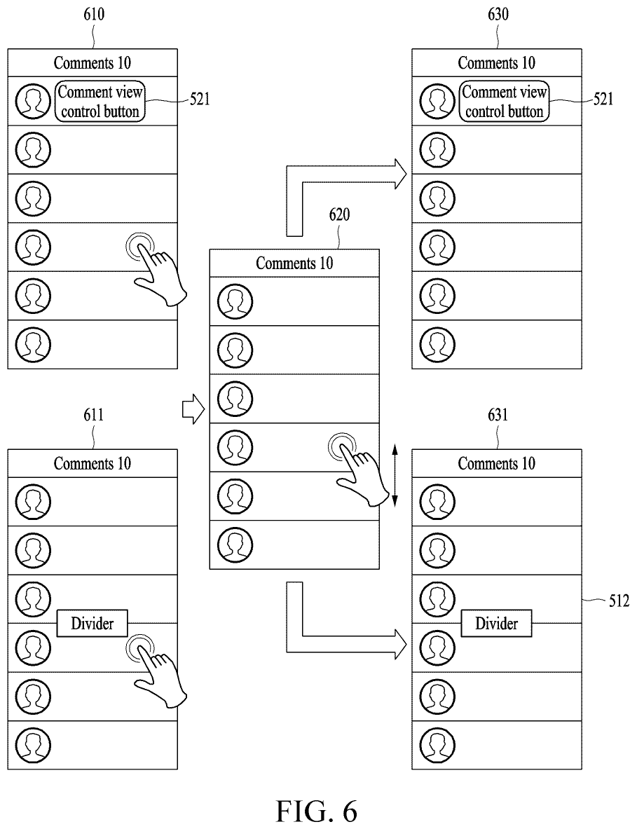

For example, FIG. 6 illustrates embodiments in which a user performs a scroll to search comments. Screens 610 and 611 may each represent screens before scroll input, screen 620 may represent a screen in a state of scroll input, and screens 630 and 631 may represent screens of scroll input results. The screen 610 may represent a screen in which the button 521 is activated, and when there is a scroll input of the user, the terminal 110 may detect the scroll input as a third user input and perform an operation of deactivating the button 521 based on the detection.

Referring to the screen 620, the terminal 110 may deactivate the button 521 during the user's scroll input when the button 521 is activated (the screen 610 is displayed). In addition, on the screen 610 before the scroll input where the button is activated, when the activated button 521 is selected, the comment view may be controlled so that the comments 512 corresponding to the comment location information are displayed, and as a result, the screen 631 may be displayed.

The terminal 110 may reactivate the button 521 (resulting in displaying the screen 630) or keep the button 521 deactivated (resulting in displaying the screen 631) depending on whether comments that are displayed when accessing the comment view are displayed in the comment view when the existing comment view is moved to another comment view at the time a scroll input is terminated on the screen 611 before the scroll input where the button is deactivated. An example where the button is reactivated will be further described below.

In an embodiment, the button 521 may be reactivated based on content displayed in the comment view as a result of the comment view being controlled by a predetermined fourth user input distinguished from the third user input while the button 521 is deactivated.

For example, when a comment that is displayed when accessing the comment view is displayed in response to a user scroll input received while the button 521 is disabled, the button 521 may be reactivated. Referring to FIG. 6, when the user scrolls on the screen 611 before the scroll input while the button 521 is disabled, the terminal 110 may detect the scroll input as a fourth user input and perform an operation of reactivating the button 521 based on the detection. When a comment list displayed in the comment view has changed in response to the scroll input according to the user's comment search, the terminal 110 may determine whether the comment that is displayed when accessing the comment view is displayed in the comment view. When the comment that is displayed when accessing the comment view is displayed in the comment view, the terminal 110 may perform an operation of reactivating the deactivated button 521 to display the screen 631.

In addition, the terminal 110 may reactivate the button 521 in response to an update request. More specifically, upon receiving the update request, the terminal 110 may receive a new list of latest comments, and display at least a portion of the comments in the list of latest comments in the comment view to reactivate the button 521. The list of latest comments may be a list of comments including the comments of the comment list received in operation 220 or a list of comments written only after the time of writing the last comment included in the comment list received in operation 220. The update request may include requests related to refresh, web reload, and the like.

The terminal 110 may dynamically manage activation, deactivation, and/or reactivation states of the button 521 to improve user experience. When a user searches comments, unnecessary interface elements may be minimized, and buttons may be activated only in certain cases, thereby contributing to improving user convenience.

According to an embodiment, although not shown in the drawing, the terminal 110 may store location information of the latest comment displayed when accessing the comment view in response to the post and identification information of a user. The stored location information (e.g., next comment index) may be used as comment location information (e.g., current comment index) at the next time of accessing the comment view of the same post using the same user's identification information. The location information of the latest comment displayed at the current time of access may be used as comment location information at the next time of access. In other words, the comment location information may correspond to location information previously stored at a previous time of accessing the comment view of a post using the identification information.

For example, the terminal 110 may store the next comment index in a local storage of the terminal 110. The terminal 110 may store the next comment index as app data in a cache memory of the terminal 110 in response to the post and identification information, but is not necessarily limited thereto.

The server 120 may receive the next comment index corresponding to the post and identification information from the terminal 110, and store the next comment index in a database of the server 120. The next comment index may be stored in the database of the server 120 together with the post information and the identification information. The server 120 may acquire the next comment index by searching the database based on a query based on the post information and the identification information, and may transmit the acquired next comment index to the terminal 110.

The terminal 110 may input the next comment index acquired while accessing the comment view to the current comment index, and then perform the operations of the above-described embodiments based on the current comment index. The terminal 110 may store the location information of the latest comment at the time of accessing the comment view as the next comment index for the next access.

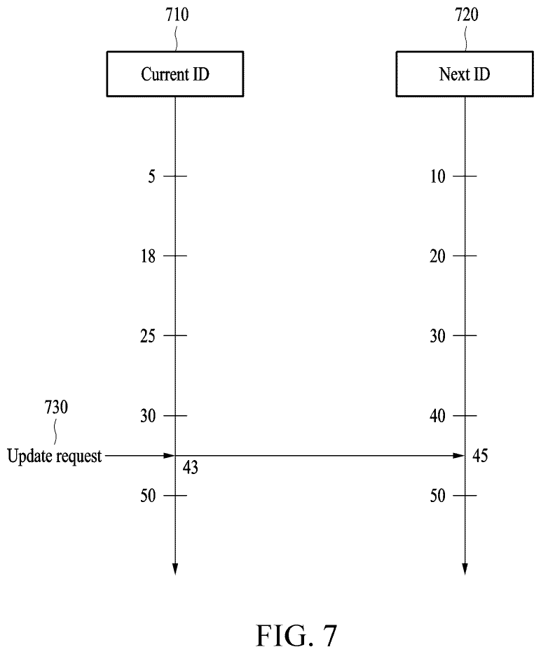

FIG. 7 is a flowchart illustrating an operation of updating comment location information to changed comment location information. The method of providing a comment view may further include at least one of updating comment location information (e.g., a current ID) used in a current access according to a predetermined first condition and updating stored location information (e.g., a next ID) for a next access according to a predetermined second condition.

According to an embodiment, the terminal 110 may update the comment location information in response to a user input. The comment location information described above is referred to as “existing comment location information” below to distinguish it from the changed comment location information.

According to an embodiment, when it is determined that a comment corresponding to an index corresponding to a predetermined difference based on an index corresponding to the comment location information of a comment list is displayed in the comment view, the comment location information may be updated in response to an index corresponding to a predetermined difference. For example, the terminal 110 may automatically update the comment location information when a predetermined number of comments are displayed in the comment view after the comment corresponding to the comment location information. In addition, the predetermined difference may be a value set to be dynamically changed according to a user input (e.g., a scroll input), a fixed value according to a user setting, or a value that varies according to a server setting. Through this update, by storing the last previously read location or a location close thereto, user experience may be improved by providing a comment view based on the corresponding location upon re-entry.

For example, a sequence list of a comment list may sequentially include nodes according to an order in which comments are written, the predetermined difference may be 10, and an index of a comment corresponding to existing comment location information may be 20. When it is determined that 10 comments written after the comment corresponding to the existing comment location information are displayed in the comment view, the existing comment location information may be updated with comment location information corresponding to index 30.

According to an embodiment, the terminal 110 may update previously stored location information according to a predetermined second condition.

According to an embodiment, when the terminal 110 newly receives a list of latest comments from a server, and it is determined that a latest comment corresponding to an index corresponding to a predetermined difference is displayed in the comment view, the terminal 110 may automatically update stored location information corresponding to the index corresponding to the predetermined difference based on an index corresponding to the stored location information (e.g., a next comment index) of the comment list. The predetermined difference may be a fixed value according to a server or user setting, or may be a dynamic value that may vary depending on the received list of latest comments. When the predetermined difference is a dynamic value that may vary depending on the list of the latest comments, and is a difference value between the last index of the list of the latest comments and the stored location information, the terminal 110 may update the stored location information to location information corresponding to the last index of the list of the latest comments.

For example, when the comment view is accessed, a comment list received from the server may include a sequence list having indices from 1 to 40, a predetermined difference may be 5, and an index of the stored location information may be 33. When the terminal 110 determines that a comment corresponding to index 38, which is a difference of 5 based on the index 33 of the stored location information, is displayed in the comment view, the terminal 110 may update the index of the stored location information to 38. According to an embodiment, the terminal 110 may update the index of the stored location information to 40, which is the last index of the comment list.

According to an embodiment, the method of providing a comment view may further include at least one of identifying at least one of a first condition and a second condition at predetermined time intervals and identifying at least one of the first condition and the second condition according to a user's update request. For example, when the predetermined time is 30 minutes, the terminal 110 may identify whether at least one of the first condition and the second condition is satisfied every 30 minutes. In this example, the predetermined time may vary depending on the user setting.

The update request may include a request to refresh the comment view or switch to another screen, or the like. When there is an update request, the terminal 110 may identify whether at least one of the first condition and the second condition is satisfied. The refresh may be performed through an interfacing object included in a comment view providing interface or a swipe gesture, or the like. The switch to another screen may occur according to a user's input for a link, a menu tab, an in-app browser, a profile button, a back button, or the like displayed in the comment view. For example, FIG. 7 illustrates an example in which the comment location information and stored location information are changed at predetermined time intervals or according to an update request. Flowchart 710 shows the change of the comment location information, and flowchart 720 shows the change of the stored location information. Here, the predetermined difference may be a difference value between the last index of the latest comment list and the stored location information, where the predetermined difference of the first condition may be a dynamic value that may vary depending on a user input, and the predetermined difference of the second condition may be a dynamic value that may vary depending on the latest comment list.

Each of the flowcharts 710 and 720 indicates that the comment location information and the stored location information are changed periodically at a predetermined time. When the stored location information is index 5, this may represent the comment location information at the time of access. In addition, the last index in the comment list received at the time of access, that is, the index of the most recent comment, is 10, which may represent the location information stored at the time of access. The comment location information and the stored location information at the time of access may be changed at predetermined time intervals. However, when there is an update request between the predetermined time intervals, the comment location information and the stored location information may be changed based on a time point of an update request 730. For example, when the update request 730 is received, in addition to the predetermined time interval, the comment location information and the stored location information may be changed by a predetermined difference, by determining whether the first condition and the second condition are satisfied based on the time point of the update request 730.

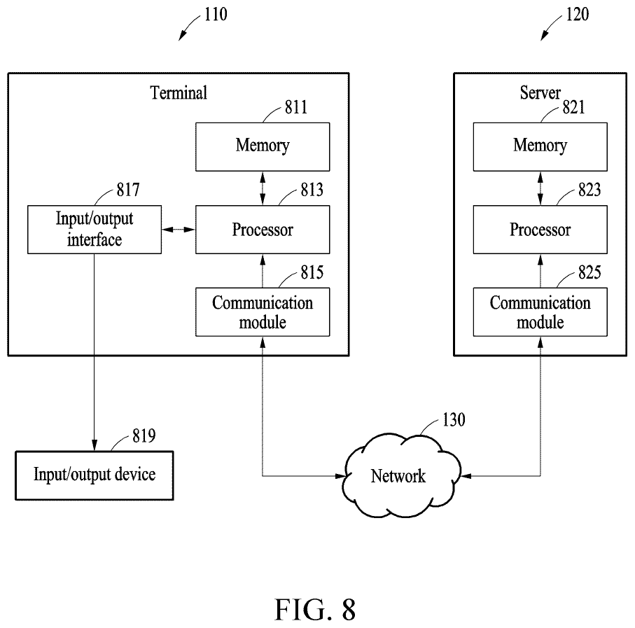

FIG. 8 is a diagram illustrating an example hardware configuration of a system for providing a comment view, according to an embodiment.

Referring to FIG. 8, a system (e.g., the system 100 of FIG. 1) according to an embodiment may include the terminal 110 and the server 120 connected through the network 130.

The terminal 110 according to an embodiment may be a mobile terminal implemented as a computer device. For example, the terminal 110 may communicate with the server 120 and/or other electronic devices through the network 130 using a wireless or wired communication scheme.

The server 120 according to an embodiment may be implemented as a computer device or a plurality of computer devices that communicate with the terminal 110 and/or another server through the network 130 to provide instructions, code, files, content, services, and the like. The communication scheme is not limited, and may include a communication scheme using a communication network (e.g., a mobile communication network, wired Internet, wireless Internet, broadcasting network) that the network 130 may include, and a short-range wireless communication scheme between devices. For example, the network 130 may include any one or more of a personal area network (PAN), a local area network (LAN), a campus area network (CAN), a metropolitan area network (MAN), a wide area network (WAN), a broadband network (BBN), and the Internet.

According to an embodiment, the server 120 may provide a file for installing an app to the terminal 110 connected through the network 130. In this case, the terminal 110 may install an app (e.g., an online community service) using the file provided from the server 120. In addition, the terminal 110 may connect to the server 120 and receive a service or content provided by the server 120 according to the control of an operating system (OS) and at least one program (e.g., a browser or an installed app) included in the terminal 110. For example, when the terminal 110 transmits a service request to the server 120 through the network 130 according to the control of an app, the server 120 may transmit code corresponding to the service request to the terminal 110, and the terminal 110 may configure and display a screen according to the code under the control of the app, thereby providing the content to the user.

According to an embodiment, the server 120 may include a memory 821, a processor 823, and a communication module 825.

The processor 823 according to an embodiment may perform at least one of the operations described above with reference to FIGS. 1 to 7. For example, the processor 823 may perform at least one operation related to the method of providing a comment view described above with reference to FIGS. 1 to 7. The processor 823 may be configured to process instructions of a computer program by performing basic arithmetic, logic, and input/output operations. The instructions may be provided to the processor 823 by the memory 821 or the communication module 825.

The memory 821 is a computer-readable storage medium, and may be a volatile memory or a non-volatile memory. The memory 821 according to an embodiment may store information for the method of providing a comment view described above with reference to FIGS. 1 to 7. For example, the memory 821 may store user account information and identification information of a user registered in an online community service, comment location information, information related to a post, a comment list, and the like. The memory 821 may store a program in which operations for the method of providing a comment view described above with reference to FIGS. 1 to 7 are implemented.

The communication module 825 according to an embodiment may provide a function for communicating with the terminal 110 through the network 130 and may provide a function for communicating with another electronic device or another server.

For example, a control signal or instruction, content, file, or the like provided according to the control of the processor 823 of the server 120 may be received by the terminal 110 through the communication module 815 of the terminal 110 via the communication module 825 and the network 130.

According to an embodiment, the terminal 110 may include a memory 811, a processor 813, a communication module 815, and an input/output interface 817.

The processor 813 according to an embodiment may perform at least one operation performed in an app or web browser installed in the terminal 110 described above with reference to FIGS. 1 to 7. The processor 813 may be configured to process instructions of a computer program by performing basic arithmetic, logic, and input/output operations. The instructions may be provided to the processor 813 by the memory 811 or the communication module 815.

The memory 811 is a computer-readable storage medium and may be a volatile memory or a non-volatile memory. The memory 811 according to an embodiment may store information for operating an app or web browser described above with reference to FIGS. 1 to 7, identification information, comment location information, information related to a post, and the like. The memory 811 may include code for an online community service installed and operated on the terminal 110 by files provided from the server 120 through the network 130.

The communication module 815 according to an embodiment may provide a function for communicating with the server 120 through the network 130. For example, a request generated by the processor 813 of the terminal 110 according to program code for an online community service stored in a storage device such as the memory 811 may be transmitted to the server 120 through the network 130 according to the control of the communication module 815.

The input/output interface 817 may be a part for interfacing with an input/output device 819. For example, an input device may include a device such as a keyboard or a mouse, and an output device may include a device such as a display for displaying a communication session of an app. As another example, the input/output interface 817 may be a part for interfacing with a device in which input and output functions are integrated, such as a touchscreen. More specifically, for example, the processor 813 of the terminal 110 may use data provided by the server 120 to display a service screen or content on the display through the input/output interface 817 when processing an instruction of a computer program loaded into the memory 811. An input received from a user through the input/output device 819 may be provided in a form that may be processed by the processor 813 of the terminal 110 through the input/output interface 817.

According to an embodiment, the terminal 110 and the server 120 may include other components not shown in FIG. 8. For example, the terminal 110 may be implemented to include at least a part of the input/output device 819 described above, or may further include other components such as a transceiver, a global positioning system (GPS) module, a camera, various sensors, a database, and the like.

The described method provides specific improvements to the operation of computer systems by enabling personalized, efficient, and context-aware comment navigation. Unlike conventional systems that present static comment threads without regard to user context or device conditions, the disclosed method evaluates real-time scroll position, screen attributes, and comment location data to manage the interface behavior dynamically.

For example, the system determines whether a previously read comment is currently visible within the viewport by comparing its index against the rendered comment range. If it is not visible, the system activates a control element that enables the user to navigate directly to the relevant location. This control is then deactivated upon completion of the navigation or based on subsequent user input such as scrolling.

These operations improve computer functionality in several ways. First, they reduce unnecessary rendering and scrolling, thereby improving computational efficiency and user interface performance. Second, they enable adaptive behavior that minimizes cognitive load on the user and prevents redundant content exposure. Third, the approach leverages both local and remote storage to manage state persistence intelligently, reducing dependency on persistent sessions or re-authentication.

This technical solution is rooted in computer technology and is not merely a business process or abstract idea. The disclosed system addresses a challenge particular to computing environments—efficiently managing dynamic user interfaces for large volumes of comment content—and provides a concrete, technically grounded solution that improves system behavior.

The embodiments described herein may be implemented using hardware components, software components, or a combination thereof. A processing device may be implemented using one or more general-purpose or special purpose computers, such as, for example, a processor, a controller and an arithmetic logic unit (ALU), a digital signal processor, a microcomputer, a field programmable array (FPGA), a programmable logic unit, a microprocessor or any other device capable of responding to and executing instructions in a defined manner. The processing device may run an OS and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct or configure the processing device to operate as desired. Software and/or data may be embodied permanently or temporarily in any type of machine, component, physical or virtual equipment, computer storage medium or device capable of providing instructions or data to or being interpreted by the processing device. The software also may be distributed over network coupled computer systems so that the software is stored and executed in a distributed fashion. The software and data may be stored by one or more non-transitory computer readable recording mediums.

The method according to the above-described embodiments may be recorded in non-transitory computer-readable media including program instructions to implement various operations which may be performed by a computer. The media may also include, alone or in combination with the program instructions, data files, data structures, and the like. The program instructions recorded on the media may be those specially designed and constructed for the purposes of the embodiments, or they may be of the well-known kind and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as code produced by a compiler, and files containing higher level code that may be executed by the computer using an interpreter.

The described hardware devices may be configured to act as one or more software modules in order to perform the operations of the above-described embodiments, or vice versa.

While this disclosure includes embodiments, it will be apparent to one of ordinary skill in the art that various changes in form and details may be made in these embodiments without departing from the spirit and scope of the claims and their equivalents. The embodiments described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, performed by a user terminal, of providing a comment view, the method comprising:
receiving a first user input accessing a comment view of a post;
receiving a comment list of the post from a server;
acquiring identification information related to a user of the user terminal;
acquiring comment location information corresponding to the post and the identification information;
displaying at least a portion of comments of the comment list on the comment view based on a screen display attribute of the user terminal;
when a comment corresponding to the comment location information is not displayed on the comment view, activating a button to control the comment view according to the comment location information; and
in response to a second user input selecting the button, controlling the comment view so that the comment corresponding to the comment location information is displayed and deactivating the button.

2. The method of claim 1, further comprising:
storing location information of the at least the portion of comments corresponding to the post and the identification information,
wherein the comment location information is location information pre-stored at a previous time point of accessing the comment view of the post by using the identification information.

3. The method of claim 1, further comprising:
in a state in which the button is deactivated, reactivating the button based on content displayed on the comment view as a result of the comment view being controlled by a predetermined fourth user input distinguished from a third user input.

4. The method of claim 3, wherein the reactivating of the button comprises at least one of:
in response to a scroll input of the user while the button is deactivated, reactivating the button when the at least the portion of comments is displayed on the comment view; and
in a state in which the button is deactivated, newly receiving a latest comment list from a server according to receiving an update request and reactivating the button by displaying at least a portion of comments of the latest comment list on the comment view.

5. The method of claim 1, wherein the acquiring of the identification information related to the user comprises at least one of:
acquiring identification information from the user terminal; and
acquiring identification information corresponding to an account of the user from a server.

6. The method of claim 1, wherein the acquiring of the comment location information corresponding to the post and the identification information comprises at least one of:
acquiring comment location information corresponding to the post and the identification information stored in the user terminal; and
acquiring comment location information corresponding to the post and the identification information from a server.

7. The method of claim 1, further comprising:
in a state in which the button is activated, deactivating the button in response to a predetermined third user input distinguished from the second user input.

8. The method of claim 7, wherein the deactivating of the button in response to the third user input comprises at least one of:
in a state in which the button is activated, deactivating the button in response to a result of a scroll input of a user; and
in a state in which the button is activated, deactivating the button while a scroll input of a user is being input.

9. The method of claim 2, further comprising at least one of:
updating the comment location information according to a predetermined first condition; and
updating the stored location information according to a predetermined second condition.

10. The method of claim 8, wherein the updating of the comment location information according to the predetermined first condition comprises,
according to a determination that a comment corresponding to an index corresponding to a predetermined difference is displayed on the comment view based on an index corresponding to the comment location information of the comment list, updating the comment location information in response to the index corresponding to the predetermined difference.

11. The method of claim 8, wherein the updating of the stored location information according to the predetermined second condition comprises,
according to a determination that a latest comment corresponding to an index corresponding to a predetermined difference is displayed on the comment view based on an index corresponding to the stored location information of the comment list, updating the stored location information in response to the index corresponding to the predetermined difference.

12. The method of claim 8, further comprising at least one of:
identifying at least one of the first condition and the second condition at predetermined time intervals; and
identifying at least one of the first condition and the second condition according to an update request.

13. A user terminal, comprising:
at least one processor; and
memory storing a program readable by the at least one processor,
wherein the program comprises instructions that cause the at least one processor to:
receive a first user input accessing a comment view of a post;
receive a comment list of the post from a server;
acquire identification information related to a user of the user terminal;
acquire comment location information corresponding to the post and the identification information;
display at least a portion of comments of the comment list on the comment view based on a screen display attribute of the user terminal;
when a comment corresponding to the comment location information is not displayed on the comment view, activate a button to control the comment view according to the comment location information; and
in response to a second user input selecting the button, control the comment view so that the comment corresponding to the comment location information is displayed and deactivate the button.

14. The user terminal of claim 13, wherein the program further comprises instructions that cause the at least one processor to,
store location information of the at least the portion of comments corresponding to the post and the identification information,
wherein the comment location information is location information pre-stored at a previous time point of accessing the comment view of the post by using the identification information.

15. The user terminal of claim 13, wherein the program further comprises instructions that cause the at least one processor to,
in a state in which the button is deactivated, reactivate the button based on content displayed on the comment view as a result of the comment view being controlled by a predetermined fourth user input distinguished from a third user input.

16. The user terminal of claim 15, wherein the reactivating of the button comprises at least one of:
in response to a scroll input of the user while the button is deactivated, reactivating the button when the at least the portion of comments is displayed on the comment view; and
in a state in which the button is deactivated, newly receiving a latest comment list from a server according to receiving an update request and reactivating the button by displaying at least a portion of comments of the latest comment list on the comment view.

17. The user terminal of claim 13, wherein the program further comprises instructions that cause the at least one processor to,
in a state in which the button is activated, deactivate the button in response to a predetermined third user input distinguished from the second user input.

18. The user terminal of claim 14, wherein the program further comprises instructions that cause the at least one processor to execute at least one of:
updating the comment location information according to a predetermined first condition; and
updating the stored location information according to a predetermined second condition.

19. The user terminal of claim 18, wherein the updating of the comment location information according to the predetermined first condition comprises,
according to a determination that a comment corresponding to an index corresponding to a predetermined difference is displayed on the comment view based on an index corresponding to the comment location information of the comment list, updating the comment location information in response to the index corresponding to the predetermined difference.

20. The user terminal of claim 18, wherein the updating of the stored location information according to the predetermined second condition comprises,
according to a determination that a latest comment corresponding to an index corresponding to a predetermined difference is displayed on the comment view based on an index corresponding to the stored location information of the comment list, updating the stored location information in response to the index corresponding to the predetermined difference.
